(19) United States
(12) Patent Application Publication
(10) Pub. No.: US 2006/0047738 A1
(43) Pub. Date: Mar. 2, 2006

(54) Decimal rounding mode which preserves data information for further rounding to less precision

(75) Inventors: Eric M. Schwarz, Gardiner, NY (US); Martin S. Schmookler, Austin, TX (US)

Correspondence Address: Lynn L. Augspurger;IBM Corporation, P386, 2455 South Road, Poughkeepsie, NY, 12601, US

(73) Assignee: International Business Machines Corporation, Armonk, NY (US)

(21) Appl. No.: 10/930,129

(22) Filed: Aug. 31, 2004

(51) Int. Cl. G06F 7/38

(52) U.S. Cl. 708/490

(57) ABSTRACT

A method of processing data employs a new rounding mode called “round for reround” on the original arithmetic instruction in the hardware precision, and then 2) invoking an instruction which specifies a variable rounding precision and possibly explicitly sets the rounding mode which we have called the ReRound instruction. The precise result of the arithmetic operation is first truncated to the hardware format precision “p”, forming an intermediate result. If only zeros are dropped during truncation, then the intermediate result is equal to the precise result, and this result is said to be “exact”, otherwise, it is “inexact”. When the intermediate result is inexact and its least significant digit is either zero or five, then that digit is incremented to one or six respectively forming the rounded result. Thus, when the least significant digit of a rounded result is zero or five the result could be construed to be exact or exactly halfway between two machine representations if it were later rounded to one less digit of precision. For all other values, it is obvious that the result is inexact and not halfway between two machine representations for later roundings to fewer than “p” digits of precision. A nice mathematical property of this rounding mode is that results stay ordered and in a hardware implementation it is guaranteed that the incrementation of the least significant digit does not cause a carry into the next digit of the result.

### TRADEMARKS

IBM® is a registered trademark of International Business Machines Corporation, Armonk, N.Y., U.S.A.

### BACKGROUND OF THE INVENTION

1. Field of the Invention

This invention relates to computer processing systems, and particularly to a method for handling floating point instructions in a computer processing system.

2. Description of Background

There is a problem for a hardware implementation, such as that illustrated generally by IBM's U.S. Pat. No. 5,880,984 having a floating point arithmetic unit for performing independent multiply and add operations in the execution of a multiply-add instruction on three operands A, B, and C, wherein A being the multiplicand, C being the multiplier and B being the addend, and each operand comprising data of a prescribed number p of bits in accordance with a given floating-point precision including one (1) sign bit indicating if a data represents a positive (+) or a negative (−) value, X exponent bits, and y mantissa bits, for the microprocessor arithmetic unit to perform rounding to multiple precisions and create the exactly rounded result as if the machine had performed only one rounding from the infinitely precise intermediate result. In decimal arithmetic employed in microprocessor based computer processing systems, especially those used for financial transactions applications, it is common to round a result to a defined precision which may vary between or within an application. One calculation may need to round a result to 6 digits of precision while another must produce a result to 10 digits of precision, while the underlying hardware produces a result to 16 digits of precision. A mechanism is needed for performing rounding to a variable precision without loss of accuracy caused by rounding twice.

### SUMMARY OF THE INVENTION

The preferred embodiment of the invention provides a computer processing system with the ability to handle a decimal rounding mode which preserves data information for further rounding to less precision for floating point operations with a round to reround instruction.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 illustrates the table utilized to illustrate the preferred embodiment of the invention for a computer processing system employing a microprocessor.

The detailed description explains the preferred embodiments of the invention, together with advantages and features, by way of example with reference to the drawings.

### DETAILED DESCRIPTION OF THE INVENTION

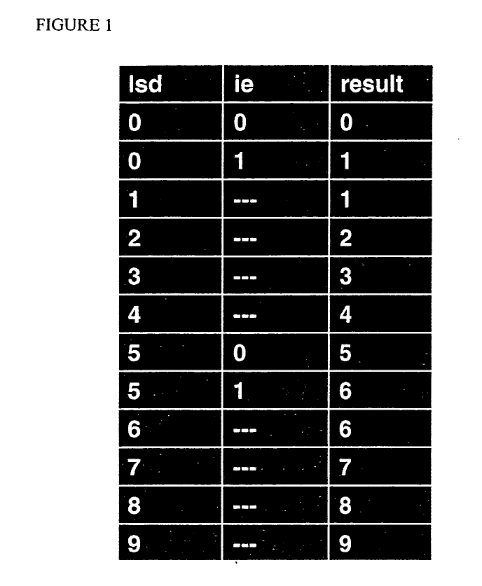

FIG. 1 illustrates the table utilized to illustrate the preferred embodiment of the invention for a computer processing system employing a microprocessor.

This system is useful for financial applications run on microprocessor based computer processing systems, and will be seen to be an improvement to the now standard IEEE 754 Floating Point. It can be proved that a system can round to “p” digits of precision a result that was previously rounded to “2p+2” digits of precision without causing double rounding errors. The current IEEE 754 binary floating point standard defines the significands of single, double, and a proposed quadword format such that this criteria is met (24, 53, and 113 bits in each format). Each format is greater than a little over twice the width of the next smaller precision. There has been developed a current IEEE754 revision developed by a committee which has agreed on decimal floating-point formats of 7, 16, and 34 digits which also satisfy this requirement. When we considered this development we wondered how can a computer system be developed where a user can run applications which round to 10 digits accurately if the original arithmetic operation were rounded to 16 digits. Such an application would now meet the revised requirement, one which does not meet this criteria.

We will describe our improvement with respect to the table of FIG. 1. The first requirement is to create an instruction which rounds to a user specified precision which is variable, which we call the “ReRound” instruction. And the second requirement is that the original arithmetic operation in the higher precision somehow maintains information about the infinitely precise intermediate result. This information is used to prevent incorrect double rounding and enables the hardware to construct an equivalent operand, which when rounded to a smaller precision using the ReRound instruction, produces the same result as if rounding the original infinitely precise operand. Prior methods for maintaining this information about the infinitely precise result have included recording in a status word whether the rounded target is inexact and in a few cases some architectures have also provided a bit indicating whether it was rounded up. This allows rounding of a “p” digit result to a “p−1” or less digits of precision. One other method previously mentioned is to only round to only “((p/2)−1)” where “p” is the precision of the target of an arithmetic operation (i.e. 7, 16 or 34 digits depending on hardware format chosen). Choosing to limit the rounding capabilities to less than half the machine precision is severely limiting. And using the status word to maintain the additional information creates a bottleneck for performance.

For binary floating-point there was a solution proposed to create a new rounding mode, but the extension to decimal is not straightforward. For binary floating-point the new rounding mode truncates and logically ORs the sticky bit into the least significant bit.

The preferred embodiment of our invention eliminates the performance bottleneck of updating and reading the floating-point status word of prior applications and provides the capability of secondary roundings up to “p−1” digits of precision where the first rounding was to “p” digits of precision. The mechanism for providing this information is to create a new rounding mode which maintains this information within the result of the first rounded result which was rounded to the hardware format precision. This rounding mode creates a result which will round equivalently to “p−1” digits or less of precision as the original infinitely precise result. By doing this, the extra information is contained completely within the operand and there is no bottleneck in using the floating-point status word. And given that the information is contained within the operand, multiple independent operations can be placed in between these two instructions (the original arithmetic instruction to hardware precision and the subsequent rerounding to lesser precision).

The preferred embodiment of our invention provides a new rounding mode called “round for reround”. The precise result of the arithmetic operation is first truncated to the hardware format precision “p”, forming an intermediate result. If only zeros are dropped during truncation, then the intermediate result is equal to the precise result, and this result is said to be “exact”, otherwise, it is “inexact”. When the intermediate result is inexact and its least significant digit is either zero or five, then that digit is incremented to one or six respectively forming the rounded result. Thus, when the least significant digit of a rounded result is zero or five the result could be construed to be exact or exactly halfway between two machine representations if it were later rounded to one less digit of precision. For all other values, it is obvious that the result is inexact and not halfway between two machine representations for later roundings to fewer than “p” digits of precision. A nice mathematical property of this rounding mode is that results stay ordered and in a hardware implementation it is guaranteed that the incrementation of the least significant digit does not cause a carry into the next digit of the result.

FIG. 1 shows a representation of the preferred embodiment for the “round for reround” mode. Here is a rounding table, where lsd denotes the least significant digit in the target format of the intermediate result, ie represents when one that it is inexact, and result specifies the action to be taken for setting of the least significant digit of the rounded result.

This embodiment could be used by implementations of Decimal Floating-Point format proposed in the next revision to the IEEE 754 Binary Floating-Point Standard and implemented in a hardware implementation of this Decimal Floating-Point format. This a robust method of rounding to lesser precision than the hardware format. It removes any dependencies between writing and reading a single point such as the floating-point status word and instead can be implement in systems providing an interlock between writing and reading operands into registers. With this new interlock mechanism the two instructions could be separated in time by any number of independent instructions.

An example of this is our preferred embodiment of a method to multiply two operands in a 16 digit hardware format but later round the answer to 15 digits in rounding mode where the operand is rounded to the nearest representable number in the target format and in case of a tie is rounded to the lower magnitude. One could also call this rounding mode round half down).

This method can be illustrated as follows:

Using Round for Reround Rounding Mode:
employing a decimal multiply intermediate product, say 1.23456789012344560111
and rounding the decimal multiply intermediate product to 16 digits using our round for reround mode, which in the illustration would yield 1.234567890123446
and then later applying an instruction reround to 15 digits, which in the illustration yields 1.23456789012345.

It will be noted that if instead the decimal multiply were rounded toward zero the 16 digit result would be 1.234567890123445
and then applying the instruction reround to 15 digits would yield 1.23456789012344 which is a wrong result.

So, in accordance with the preferred embodiment, rounding to less digits accurately involves two functions, 1) using a new rounding mode called round for reround on the original arithmetic instruction in the hardware precision, and then 2) invoking an instruction which specifies a variable rounding precision and possibly explicitly sets the rounding mode which we have called the ReRound instruction.

While the preferred embodiment to the invention has been described, it will be understood that those skilled in the art, both now and in the future, may make various improvements and enhancements which fall within the scope of the claims which follow. These claims should be construed to maintain the proper protection for the invention first described.

What is claimed is:

1. A method of performing a decimal arithmetic operation in a microprocessor, comprising the steps of:
performing the decimal arithmetic operation and producing a result in the hardware specified precision, and later rounding the result to less digits of precision in a user specified rounding mode.

2. A method of performing decimal arithmetic operations in a microprocessor, comprising the steps of:
employing a decimal arithmetic operation,
and rounding the result to a hardware format precision using a round for reround mode, and
later applying an instruction reround to round to any specified rounding mode to less digits than the hardware format precision.

3. The method according to claim 2 wherein said round for reround mode is executed on an original arithmetic instruction with the precision specified for the hardware specified precision.

4. The method according to claim 2 wherein said round for reround mode is executed on an original arithmetic instruction with the precision specified for the hardware specified precision, and then an instruction is invoked which specifies a variable rounding precision.

5. The method according to claim 5 wherein said invoked instruction is a ReRound instruction.

6. The method according to claim 5 wherein said ReRound instruction explicitly sets the rounding mode.

7. The method according to claim 6 wherein said precision specified for the hardware specifies the precise result of an arithmetic operation which is first truncated to the hardware format precision “p”, forming an intermediate result.

8. The method according to claim 7 wherein if only zeros are dropped during truncation, then an intermediate result is equal to the precise result, and this result is determined to be “exact”, otherwise, it is “inexact”.

9. The method according to claim 8 wherein when the intermediate result is inexact and its least significant digit is either zero or five, then that digit is incremented to one or six respectively forming the rounded result.

10. The method according to claim 9 wherein when a least significant digit of a rounded result is zero or five the result is to be construed to be exact or exactly halfway between two machine representations if it were later rounded to one less digit of precision.

11. The method according to claim 10 wherein when the rounded result is not equal to zero or five, then that the result is to be construed as inexact and not halfway between two machine representations for later roundings to fewer than “p” digits of precision.

12. The method according to claim 1. wherein the result specifies the action to be take for setting of least significant digit of a rounded result.

13. The method according to claim 12 said method of rounding to lesser precision than the specified hardware precision removes any dependencies between writing and reading a single point providing an interlock mechanism between writing and reading operands into registers.

14. The method according to claim 13 wherein said interlock mechanism enables two instructions to be separated in time by any number of independent instructions.
